(19) United States
(12) Patent Application Publication
(10) Pub. No.: US 2006/0083585 A1
(43) Pub. Date: Apr. 20, 2006

(54) Break-away cradle or sub-frame mount and retainer washer assembly

(75) Inventors: John G Lew, Fort Wayne, IN (US); Scott Bykowski, Angola, IN (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignees: Cooper Technology Services, LLC, Findlay, OH (US); Cooper-Standard Automotive Inc., Novi, MI (US)

(21) Appl. No.: 10/521,954

(22) PCT Filed: Jul. 25, 2003
(86) PCT No.: PCT/US03/23175

§ 371 Date: Jan. 21, 2005

Related U.S. Application Data
(60) Provisional application No. 60/398,847, filed on Jul. 25, 2002.

(51) Int. Cl. F16D 1/08

(52) U.S. Cl. 403/365

(57) ABSTRACT

An isolator assembly (20) such as a cradle mount or a body mount assembly incorporates break-away features. An insert (70,70′) includes a thinned cross-sectional region (100) or a gap/interface (90) between insert portions (70a, 70b) that allow a bolt (24) to break-away under a predetermined load in a fore direction (80) and an aft direction (90). In addition, a retainer washer (50) may have an irregular configuration such as a tear-drop or clover-leaf configuration that cooperates with the insert (70, 70′) to allow the isolator assembly (20) to pull away in the negative z-direction under a predetermined load.

### BACKGROUND OF THE INVENTION

The present invention relates to an improved isolator assembly that secures a body, such as a vehicle body, to an associated support, such as a vehicle frame or cradle, and absorbs vibrations or shocks therebetween. More particularly, the invention relates to a body or cradle mount assembly, here more generally referred to as an isolator assembly, as particularly used in the automotive industry. It will be appreciated, however, that the invention may find application in related fields.

Present industry standards form a “hard” joint between a vehicle body and a frame. Thus, during an event such as a front impact incident or side impact event, a frame or cradle of the vehicle can remain secured to the body or passenger compartment. For example, where a cradle mount assembly interconnects the body to a cradle, its function is two-fold. The cradle mount or isolator assembly isolates vibrations between the cradle and the body. Secondly, the assembly acts as an attachment point of the cradle to the body.

In its most basic form, an isolator assembly such as a body mount assembly or cradle mount assembly includes an elastomeric member such as a block of rubber. The elastomeric/rubber member is positioned between the first structure or frame of the vehicle and a second structure or vehicle body to absorb vibrations and isolate transmission of vibration energy and impact energy between the vehicle body and frame. A fastener assembly extends longitudinally through the elastomeric member and includes a retainer such as a nut on an opposite side of the frame or body from a head end of the bolt. Thus, the frame and body are secured together via the isolator assembly and vibration energy is effectively absorbed between these components by the elastomeric member. Of course, those skilled in the art appreciate that more complex isolator assemblies include additional structural components and features than described above.

It has been deemed desirable, however, to allow selective separation between the two structures, i.e., the frame and body, during a barrier event. Heretofore, no effective design to meet this criteria has been proposed. In addition, such a design must be easily manufactured and cost effective, while still providing acceptable vibration absorbing characteristics as achieved with commercially available isolator assemblies.

### SUMMARY OF INVENTION

An improved isolator assembly includes an insert configured to break away in a desired direction in response to a predetermined load and thereby allow the cradle or frame to separate from the vehicle body.

The isolator assembly includes an elastomeric member that couples the associated frame to the associated body. An elongated fastener assembly secures the elastomeric member to the associated frame and body. An insert is received in the elastomeric member and configured to break in at least one of fore and aft directions extending along and substantially perpendicular to the length of the fastener assembly.

The insert in one embodiment is generally a hollow sleeve having a variable cross-section.

In another embodiment, the insert is a split member defined by first and second portions.

A retainer preferably includes a break away configuration allowing separation of the frame and body generally along an axis parallel to or coincident with the longitudinal axis of the fastening assembly.

The retainer preferably includes small and large diameter portions spaced around an irregular opening formed therethrough.

A primary advantage of the invention is the ability of the isolator assembly to break away at a predetermined load.

Another advantage of the invention is the ability to control the direction and predetermined load at which the isolator assembly breaks away.

Still another advantage of the invention is the simple design that is easy to manufacture and alter for various vehicle platforms or styles.

A still further advantage of the invention resides in a simplified design for ease of assembly.

Still other features and benefits of the invention will become apparent to those skilled in the art upon reading and understanding the following detailed description.

### BRIEF DESCRIPTION OF DRAWINGS

The drawings are intended to illustrate one or more preferred embodiments of the invention. The drawings, however, should not be construed to limit the invention to the illustrated embodiments.

FIG. 1 is an exploded perspective view of one embodiment of the isolator assembly of the present invention.

FIG. 2 is a longitudinal cross-sectional view of the assembled isolator assembly.

FIG. 3 is a top plan view of the isolator assembly.

FIG. 4 is an enlarged view of a portion of FIG. 3.

FIG. 5 is a cross-sectional view taken generally along the lines 5-5 of FIG. 3.

FIG. 6 is a top plan view of a first preferred insert.

FIG. 7 is a cross-sectional view taken generally along the lines 7-7 of FIG. 6.

FIG. 8 is a top plan view of a second preferred insert.

FIG. 9 is a cross-sectional view taken generally along the lines 9-9 of FIG. 8.

FIG. 10 is a top plan view of a preferred retainer.

FIG. 11 is an elevational view of the retainer of FIG. 10.

### DETAILED DESCRIPTION OF THE INVENTION

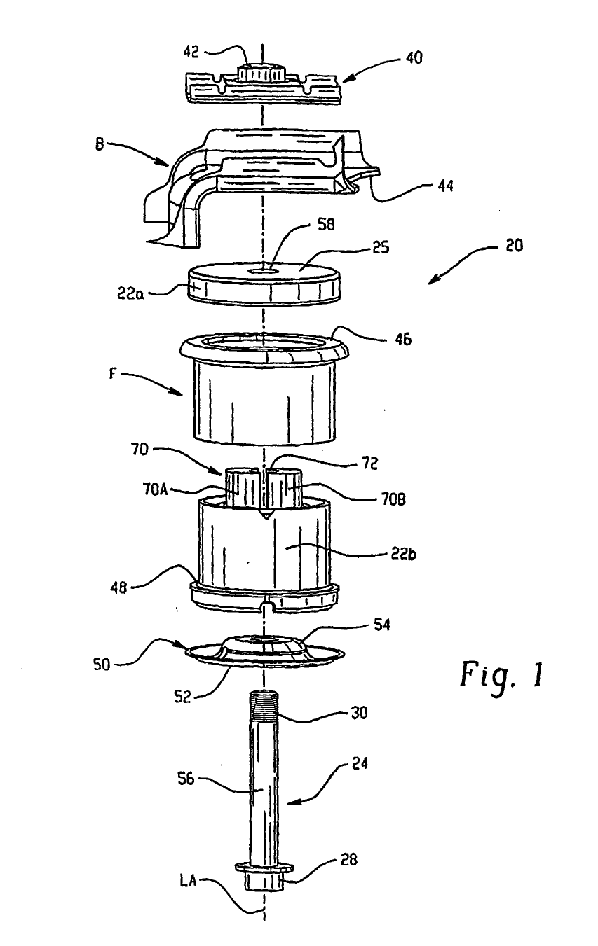

Turning first to FIG. 1, an isolator assembly 20, which in this particular illustrated embodiment is a cradle mount assembly, interconnects a body B of a vehicle to a frame F such as the illustrated cradle sleeve. More particularly, the isolator assembly includes an elastomeric or rubber member which in this embodiment comprises a first or upper insulator 22a and a second or lower insulator 22b. Each insulator has a generally annular shape with a through-opening adapted to receive a portion of the fastener assembly such as elongated bolt 24 therethrough. Of course, it will be appreciated that the insulators may adopt a wide array of configurations as may be required for various needs such as different vibration absorbing or damping rates in different directions, or may or may not include washers, inserts, stiffeners, etc, such as washer 25 that is associated with the upper insulator. The washer provides a durable wear surface that interfaces with the body B and other components of the assembly as will be described in greater detail below.

The bolt includes a first end or large head 28 and is preferably threaded at a second end 30 for threaded cooperation with a retention clip 40. The retention clip includes nut 42. As is generally known in the art, the elastomeric members 22, 24 absorb vibration energy that would otherwise be transferred between the frame and body. Thus, the upper insulator 22 abuttingly engages a first or lower surface 44 of the body sheet metal B and abuttingly engages a first end 46 of the cradle sleeve F. The cradle sleeve F is a generally hollow, cylindrical member that encompasses or encloses a substantial portion of the lower insulator 24. Typically, the lower insulator is mold bonded to the sleeve, although this should not be deemed a limiting feature of the present invention. The cradle sleeve and lower insulator engage along a stepped region 48 so that vibration energy is effectively transferred therebetween.

A second or lower retainer 50 is engaged on a first or upper surface 52 by the bolt head 28. A second or opposite surface 54 of the lower retainer faces inwardly toward the lower insulator 24.

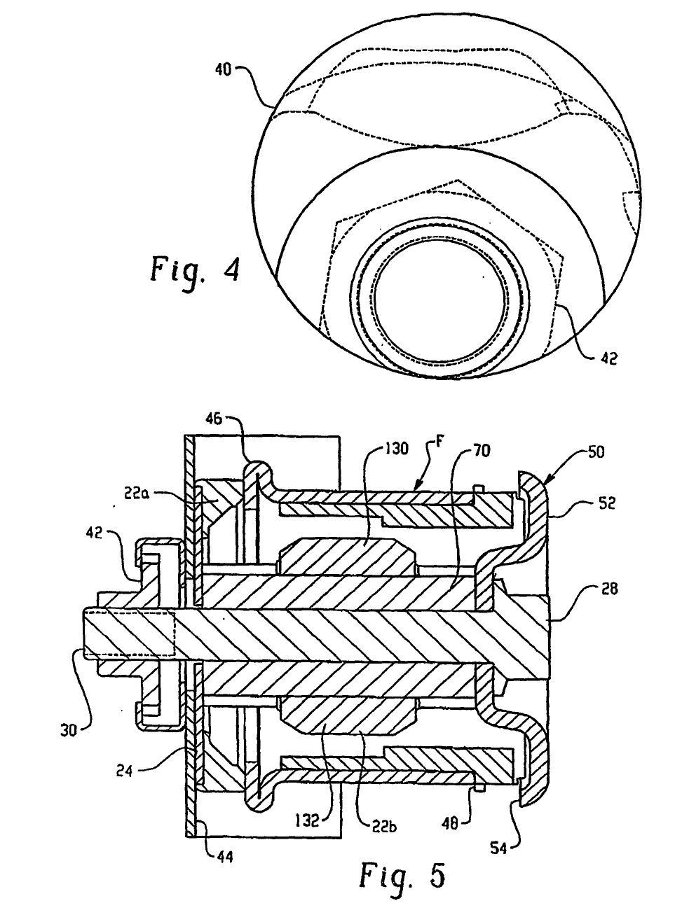

Extending axially around a shank 56 of the bolt and received radially between the shank and inner diameter portions 58, 60 of the upper and lower insulators, respectively, is an insert 70. In one embodiment, the insert 70 is formed of first and second portions 70a, 70b split along a longitudinal axis that is substantially parallel to longitudinal axis LA of the fastener. The insert 70 has a central opening 72 that receives the shank 56 of the bolt therethrough. The insert is configured to break away in at least one of the fore and aft directions, i.e., substantially perpendicular to the longitudinal axis or length of the fastener bolt in the area of a reduced cross-section when the fastener is a single member or along the gap or mating edges when the insert is defined by first and second portions 70a, 70b. The fore and aft directions are generally represented by reference numerals 80, 82, respectively in FIG. 3. As is particular evident in FIGS. 3 and 4, this is the region of the thinnest cross-section of a unitary insert, or defines the gap or mating surface between the first and second portions 70a, 70b. This is to be contrasted with the substantially larger cross-section of the insert in a direction perpendicular to the fore and aft directions. In this manner, if sufficient load is applied to the isolator assembly, such as during a barrier event, the frame F and body B will separate as a result of the bolt shearing through the gap or thinned cross-section of the insert.

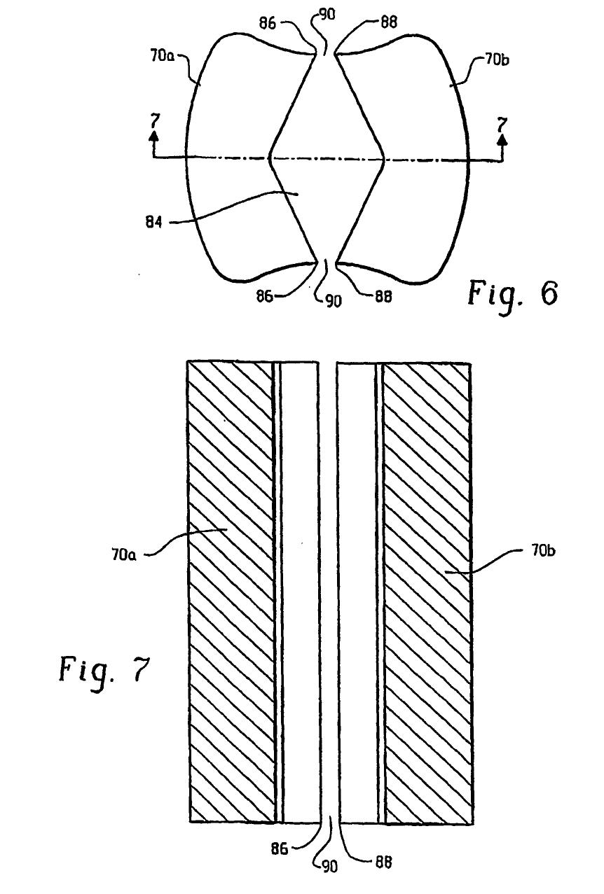

It will be appreciated that the insert may adopt a wide variety of configurations. For example, the split assembly illustrated in FIG. 1 is one arrangement. The split assembly is shown in greater detail in FIGS. 6 and 7. The split members that comprise the insert are configured or contoured to promote separation of the assembly in the fore and aft directions. That is, as seen in FIG. 6, the insert portions have a generally C-shape in the top plan view and define a generally diamond shaped opening 84 that extends the length of the split portions and surrounds and accommodates the elongated shank of the fastener. Terminal edges 86, 88 are disposed in facing relation and define small gaps 90 on either side that also extends along the full length or height of the insert. These gaps allow the fastener to pass therethrough in a vehicular event and provide the desired separation of the frame from the body.

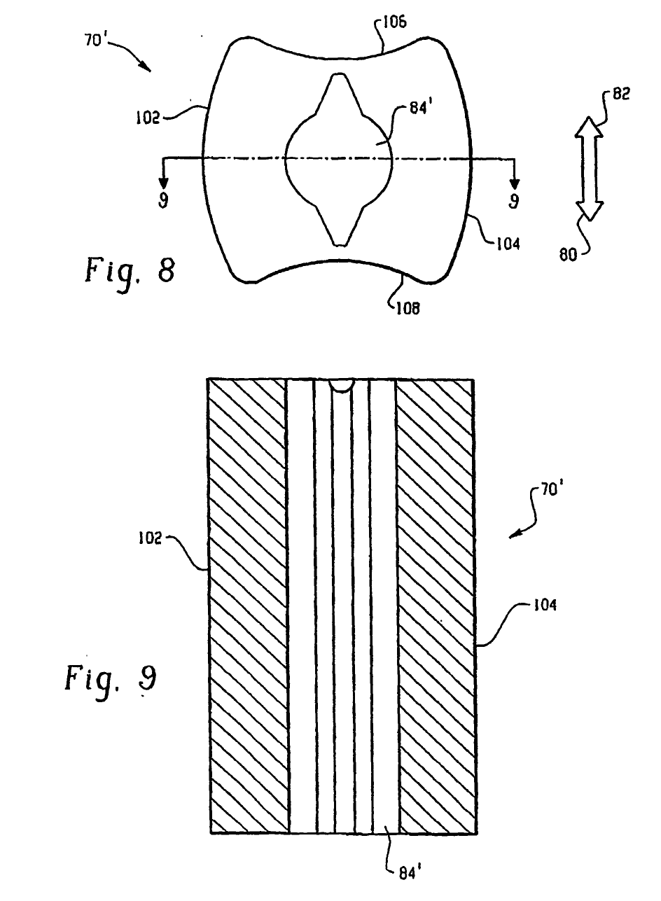

FIGS. 8 and 9 illustrate another configuration that still achieves the fore and aft break away movement or separation in the directions represented by reference arrows 80, 82 in response to a barrier event. For purposes of brevity and understanding, like reference numerals with a primed suffix (e.g., 70′) refer to like elements, and new reference numerals identify new elements. Here, the insert 70′ is a single component, i.e., not split along its length. To provide the desired response to a barrier event, the insert 70′ includes thinned cross-sections 100 in the desired fore and aft directions. For example, the convex outer surfaces 102, 104 provide a thicker cross-section in directions perpendicular to the fore and aft regions, while the thinned cross-sections include concave perimeters regions 106, 108 that in conjunction with the generally diamond-shaped opening 84′ allow the isolator assembly to break away or separate in response to a predetermined load. In all other instances, the isolator assembly continues to provide effective vibration isolation between the frame and body and an effective attachment point between these structures.

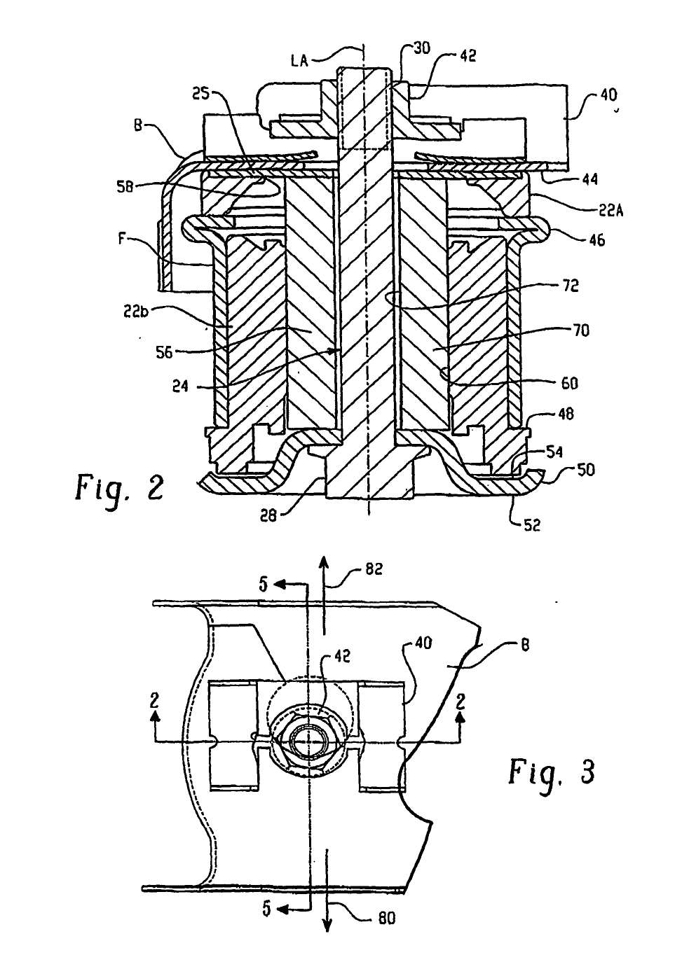

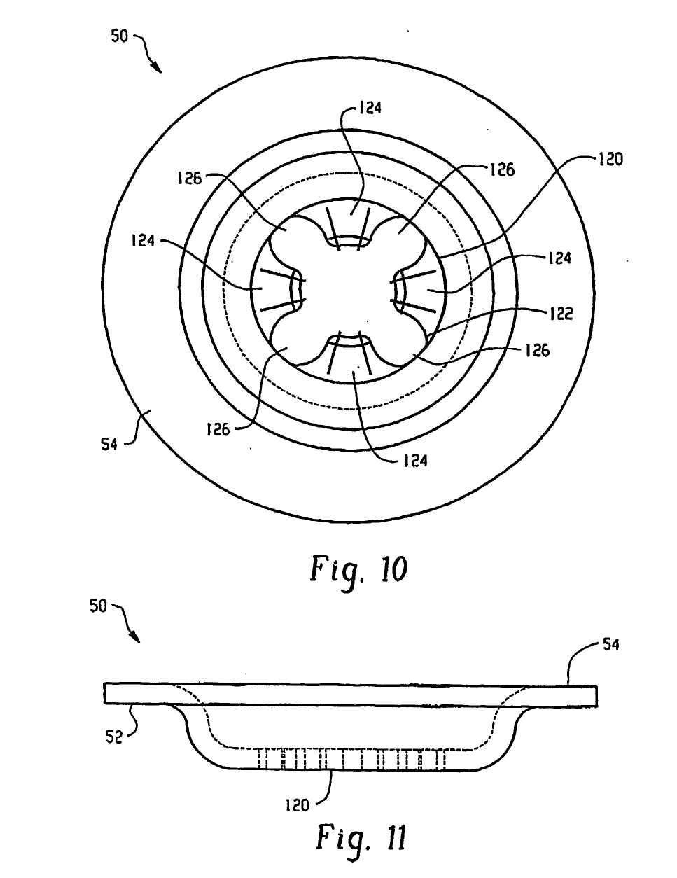

Separation in the negative z direction, along the longitudinal axis LA and the downward direction shown in FIG. 2, is also provided for break-away movement. Specifically, the insert 70 operatively engages or abuttingly engages the central portion of the upper surface 54 of the lower retainer. As best illustrated in FIGS. 6, 10 and 11, opening 120 through the retainer has an irregular or scalloped configuration 122. Lands 124 define or separate radial recesses 126 (four in number, although it will be appreciated that a greater or lesser number of lands and recesses can be used without departing from the scope and intent of the invention). The bolt head engages the lands and thus is not supported in a complete circumferential manner along the underside of the bolt head. Under a predetermined load imposed in the z-direction, the bolt head 28 separates from the retainer and thus allows the cradle to separate from the frame in the negative z-direction. Although a tear-dropped or scalloped configuration is shown as the preferred form of opening through the lower retainer, still other configurations (e.g., thinned regions) can be used to achieve the same result without departing from the scope and intent of the present invention.

It is also contemplated that one of the break-away features described above can be used independently or in combination. It is also preferable that the configuration of the insert be easily manufactured. For example, an extrudable material such as aluminum is desired because of the ease of manufacture, whether one or two-piece. It is also contemplated that the insert can be formed of different materials or in different manners such as castings, sintered or powdered metals, steel, plastics such as thermosets, thermoplastics or composites, or other combination of materials without departing from the scope and intent of the present invention. If two insert portions are used, they may be mirror images of one another, i.e., substantially identical, and to minimize manufacturing costs. On the other hand, if a unitary insert is provided, it preferably has a cross-section that is consistent throughout its length to thereby allow it to be easily manufactured.

It will also be appreciated that the design allows easy incorporation of alternative features used in other isolator assemblies. For example, fore and aft bumpers 130, 132 (FIG. 5) may be provided around the insert to provide selective isolation in those directions. Water drainage features may also be incorporated into the design without impacting on the break-away features. Still further, selected components may be manufactured to provide interlock features to facilitate ease of assembly. For example, a groove is formed in the elastomer that is bonded to the outer surface of the insert. The groove forms one portion of an interlock that cooperates with an edge formed on the upper retainer. This allows a snap-fit interlock to facilitate assembly of the upper insulator.

The invention has been described with reference to the preferred embodiments. Obviously, modifications and alterations will occur to others upon reading and understanding the preceding detailed description. It is intended that the invention be construed as including all such modifications and alterations.

Having thus described the invention, it is now claimed:

1. An isolator assembly comprising:
an elastomeric member that couples an associated frame to an associated body of an associated vehicle;
a fastener assembly securing the elastomeric member to one of the associated vehicle frame and body; and
means for allowing the fastener assembly to break away in at least one of fore and aft directions extending along and substantially perpendicular to a length of the fastener assembly.

2. The isolator assembly of claim 1 wherein the means for allowing the fastener assembly to break away in the fore and aft directions includes an insert received in the elastomeric member.

3. The isolator assembly of claim 2 wherein the insert is a generally hollow sleeve that has a variable cross-section.

4. The isolator assembly of claim 2 wherein the insert includes first and second portions that are separated along at least one of the fore and aft directions of the fastener assembly.

5. The isolator assembly of claim 4 wherein the insert first and second portions are substantially identical.

6. The isolator assembly of claim 2 wherein the insert has a cross-section that varies about its perimeter and is substantially constant along its length.

7. The isolator assembly of claim 1 further comprising a retainer that operatively engages one end of the insert, the retainer including an irregular opening therethrough that allows the isolator assembly to separate generally along a longitudinal axis of the fastener assembly.

8. The isolator assembly of claim 1 further comprising a retainer member disposed on one side of the associated body opposite from the elastomeric member for securing the fastener assembly to the associated body.

9. The isolator assembly of claim 8 wherein the retainer opening includes small and large diameter portions spaced along the irregular opening.

10. The isolator assembly of claim 1 further comprising a second elastomeric member interposed between the associated body and the associated frame.

11. A cradle mount assembly interconnecting an associated frame and an associated body of a vehicle, the cradle mount assembly comprising:
a vibration absorbing member that couples an associated frame to an associated body of an associated vehicle;
an elongated fastener assembly securing the vibration absorbing member to one of the associated vehicle frame and body;
an insert received in the vibration absorbing member and configured to break away in at least one of fore and aft directions extending along and substantially perpendicular to the length of the fastener assembly; and
a retainer that operatively engages one end of the insert, the retainer including an irregular opening therethrough that allows the isolator assembly to separate generally along a longitudinal axis of the fastener assembly.

12. The isolator assembly of claim 11 wherein the insert is a generally hollow sleeve that has a variable cross-section.

13. The isolator assembly of claim 11 wherein the insert includes first and second portions that are separated along at least one of the fore and aft directions of the fastener assembly.

14. The isolator assembly of claim 13 wherein the insert first and second portions are substantially identical.

15. The isolator assembly of claim 11 wherein the insert has a cross-section that varies about its perimeter and is substantially constant along its length.

16. An isolator assembly comprising:
an elastomeric member that couples an associated frame to an associated body of an associated vehicle;
a fastener assembly securing the elastomeric member to one of the associated vehicle frame and body; and
an insert received in the elastomeric member allowing the fastener assembly to break away in at least one of fore and aft directions extending along and substantially perpendicular to a length of the fastener assembly.

17. The isolator assembly of claim 16 wherein the insert is a generally hollow sleeve that has a variable cross-section.

18. The isolator assembly of claim 16 wherein the insert includes first and second portions that are separated along at least one of the fore and aft directions of the fastener assembly.
